(19) United States
(12) Patent Application Publication
(10) Pub. No.: US 2019/0048679 A1
(43) Pub. Date: Feb. 14, 2019

(54) SUBSEA COUPLER SYSTEM

(71) Applicant: OneSubsea IP UK Limited, London (GB)

(72) Inventor: James Stephens, Richmond, TX (US)

(21) Appl. No.: 15/671,685

(22) Filed: Aug. 8, 2017

(51) Int. Cl. E21B 33/043; F16L 13/16; E21B 33/035

(52) U.S. Cl. CPC E21B 33/043; E21B 33/035; F16L 13/166

(57) ABSTRACT

A technique provides for combining a subsea housing, e.g. a subsea low-pressure wellhead housing, and a casing. The casing may be in the form of a large diameter conductor positioned in a seabed to facilitate deployment of desired types of tubulars and other components in a subsea well. The casing is inserted into the subsea housing along an interior surface of the subsea housing. The casing is joined to the subsea housing by radial expansion of the casing until the casing is forced into a suitable engagement with the subsea housing.

### BACKGROUND

For subsea applications, hydrocarbon fluids such as oil and natural gas are obtained from a subterranean geologic formation, referred to as a reservoir, by drilling a well through a subsea wellhead system that penetrates the hydrocarbon-bearing geologic formation. In subsea applications, various types of casing and other components are deployed with and within the subsea wellhead system to reach the target depth. The casing and components often are joined by welding.

The lower part of a subsea wellhead system can be called a low-pressure housing. The low-pressure housing provides a connection at its upper end to wellhead equipment located above and provides a connection at its lower end to an attached casing. The subsea wellhead connection between the lower end of the low-pressure housing and the attached casing has to seal well pressure and also transmit mechanical loads from various directions. A common method of connecting the low-pressure housing with the casing is welding. However, the method of welding is expensive and requires extensive time and labor. Additionally, this method of connecting creates a possibility of installation errors which can lead to failure of the welded, sealed connection.

### SUMMARY

In general, a system and methodology are provided for combining a subsea housing, e.g. a subsea low-pressure wellhead housing, and a casing. The casing may be in the form of a large diameter conductor which may be positioned in a seabed to facilitate deployment of desired types of tubulars and other components in a subsea well. The casing is inserted into the subsea housing along an interior surface of the housing. The casing is joined and sealed to the subsea housing by radially expanding the casing until the casing is forced into a desired engagement with the subsea housing.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a subsea well system having a casing joined with a well related housing, according to an embodiment of the disclosure;

FIG. 2 is a cross-sectional illustration of an example of a casing, e.g. a large diameter conductor casing, joined with a well related housing, e.g. a low-pressure subsea wellhead housing, according to an embodiment of the disclosure;

FIG. 3 is an illustration of an example of the casing inserted into the subsea wellhead housing, according to an embodiment of the disclosure;

FIG. 4 is an illustration of an example of an expansion tool inserted into the casing to thus expand the casing into sealing engagement with the subsea wellhead housing, according to an embodiment of the disclosure;

FIG. 5 is an illustration of an example of the casing expanded into sealing engagement with the subsea wellhead housing, according to an embodiment of the disclosure;

FIG. 6 is an illustration of an example of the joined casing and subsea wellhead housing following withdrawal of the expansion tool and attachment of additional subsea well installation components, according to an embodiment of the disclosure; and

FIG. 7 is an illustration of another example of the casing inserted into the subsea wellhead housing and joined with the subsea wellhead housing via coupling members, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology which facilitate coupling of a subsea housing, e.g. subsea low-pressure wellhead housing, and a tubular member. The coupling may be accomplished without welds or threaded engagement. For example, the system and methodology may be used to combine a wellhead housing with a conductor casing, such as a large diameter conductor casing. The conductor casing is sometimes referred to as an extension joint and extends down into the seabed while supporting the wellhead housing at a desired spacing above the sea floor. Various other types of casings or other well completion components may be suspended from and/or disposed within the conductor tubing. By forming a coupling without welding and without threaded engagement, the life of the combined system is extended and the coupling is less susceptible to fatigue cracking and other types of wear.

According to an embodiment, the casing, e.g. large diameter conductor casing, is inserted into the subsea housing, e.g. subsea low-pressure wellhead housing, along an interior surface of the housing. The casing is joined to the subsea low pressure housing by radially expanding the casing until the casing is forced into a desired engagement, e.g. an affixed sealed engagement, with the subsea low pressure housing. In many applications, the casing is formed from a metal material and the subsea low pressure housing is formed from a metal material. In such embodiments, the radial expansion may be performed with sufficient force to create a metal-to-metal seal between the exterior of the casing and the interior of the subsea low pressure housing.

By way of example, the interior surface of the subsea housing may contain a recess or recesses, e.g. a series of grooves, into which the casing material is forced, e.g. plastically deformed, as the casing is expanded in a radially outward direction. This act of cold forming the casing material into the recesses of the subsea housing permanently affixes the casing to the subsea housing and provides desired axial, rotational, and pressure characteristics for subsea well applications. Expansion of the portion of the casing inserted into the subsea low pressure housing may be achieved via suitable expansion tools. Examples of suitable expansion tools include hydraulic forges and mechanical forges which may be used to radially expand the casing until the desired seal is formed between the casing and the surrounding subsea housing.

According to one subsea embodiment, a subsea wellhead system application connection comprises a low-pressure housing connected to a casing. It should be noted the term “casing” as used herein is meant to include many types of tubular pipe, such as a structural conductor, surface casing, production casing, production tubing casing, or other tubular members. The term subsea housing is used herein as representing many types of subsea pressure-containing housings including pressure-containing wellhead members, such as a low-pressure housing, a high-pressure housing, a casing hanger, a tubing casing hanger, and other pressure-containing housings used subsea in various types of subsea applications.

In this example, a wellhead connection is provided for connecting and sealing a casing to a low-pressure subsea wellhead housing which may generally have the form of a tubular wellhead housing. The low-pressure wellhead housing may have a top connector to connect to wellhead equipment located thereabove and a bottom connector formed with an inner surface, e.g. an inner bore, fitted with a plurality of inward radial grooves and adjacent protrusions. The grooves and adjacent protrusions form a load carrying profile and a seal profile section in the inner surface/bore to accommodate the upper portion of the casing.

The method of connecting the upper portion of the casing to the bottom connector portion of the low-pressure wellhead housing may utilize a forge tool, e.g. a special hydraulic forge tool. The hydraulic forge tool is positioned into the casing and pressured up to expand the casing beyond yield into the grooves machined in the wellhead housing along the inner surface. After the pressure is released, the wellhead housing may contract against the casing thus affixing the wellhead housing to the casing, e.g. conductor. The connection effectively forms a plurality of metal-to-metal seals and provides a connection capable of withstanding extreme cyclic loads encountered in the subsea drilling environment.

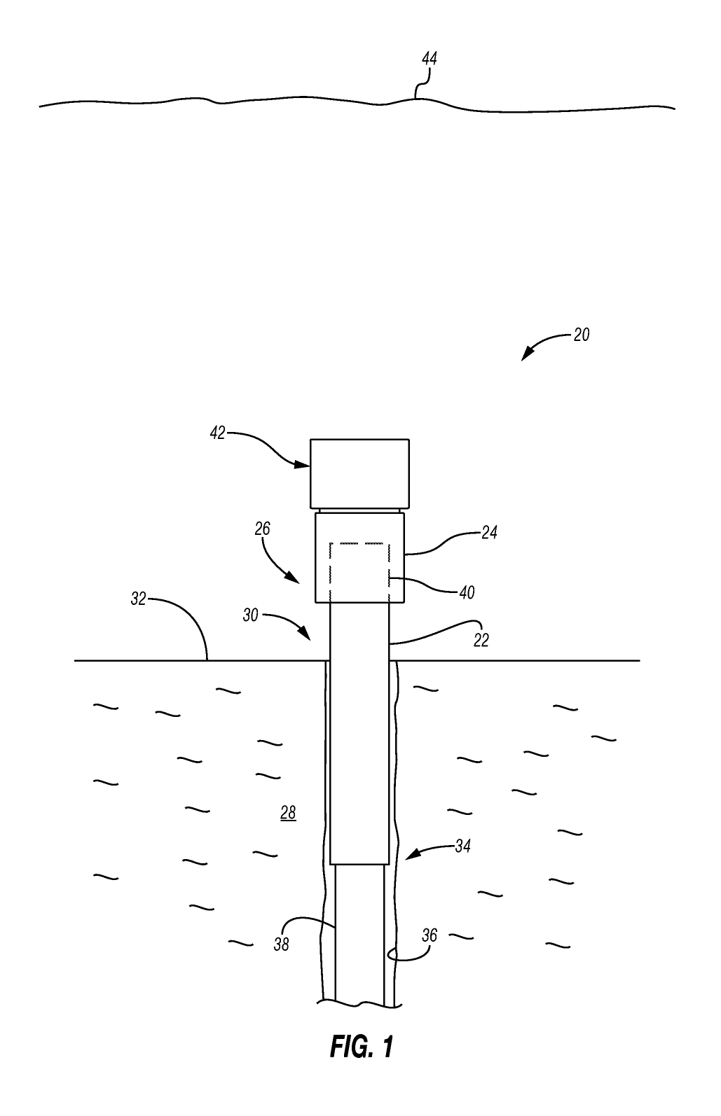

Referring generally to FIG. 1, an example of a subsea well system 20 is illustrated. The subsea well system 20 may be used in a variety of subsea well applications and generally comprises a casing 22 coupled with a subsea housing 24. In the illustrated embodiment, the subsea housing 24 is a subsea wellhead housing and the casing 22 may comprise various types of tubular members joined with the subsea housing 24. For example, the subsea housing 24 may be in the form of a subsea low-pressure wellhead housing and the casing 22 may be in the form of a conductor casing, e.g. a large diameter conductor casing, joined with the subsea low-pressure wellhead housing 24 to form subsea well system 20.

In the illustrated example, the large diameter conductor casing 22 extends into a seabed 28, e.g. into a subsea geologic formation, at a subsea location 30. The large diameter conductor casing 22 positions the subsea low pressure housing 24 at a desired spacing above a sea floor 32. The conductor casing 22 may be used at a subsea well 34 having a wellbore 36 extending down into the seabed/geologic formation 28. Various types of well tubulars 38, e.g. production casing, completion components, tubular equipment, may be suspended from, positioned in, positioned below, and/or otherwise located with respect to the conductor casing 22 for use in wellbore 36.

As illustrated, an upper end 40 of casing 22 is inserted into an interior of subsea low pressure housing 24. This portion of casing 22 is expanded in a radially outward direction. The radial expansion process may be performed with a sufficient degree of expansion and with sufficient force to form a seal between the casing 22 and the low pressure housing 24 without using welds and without threaded engagement. By way of example, the casing 22 and the housing 24 may be constructed with suitable metal materials such that the outward expansion of casing 22 creates a metal-to-metal seal between the exterior of casing 22 and the interior of housing 24. It should be noted that some embodiments may use an initial threaded engagement to engage the components prior to the expansion process.

Depending on the parameters associated with a given subsea operation, various types of subsea equipment 42 may be coupled with wellhead housing 24. By way of example, subsea equipment 42 may comprise additional portions of the subsea wellhead as well as other equipment mounted to the subsea wellhead, e.g. a blowout preventer. In some applications, risers or other equipment may extend upwardly above the subsea wellhead housing 24 toward a surface 44. Various types of surface vessels, platforms, or other surface facilities may be located at surface 44 generally above well 34 to facilitate, for example, drilling operations, completion operations, production operations, or other well related operations.

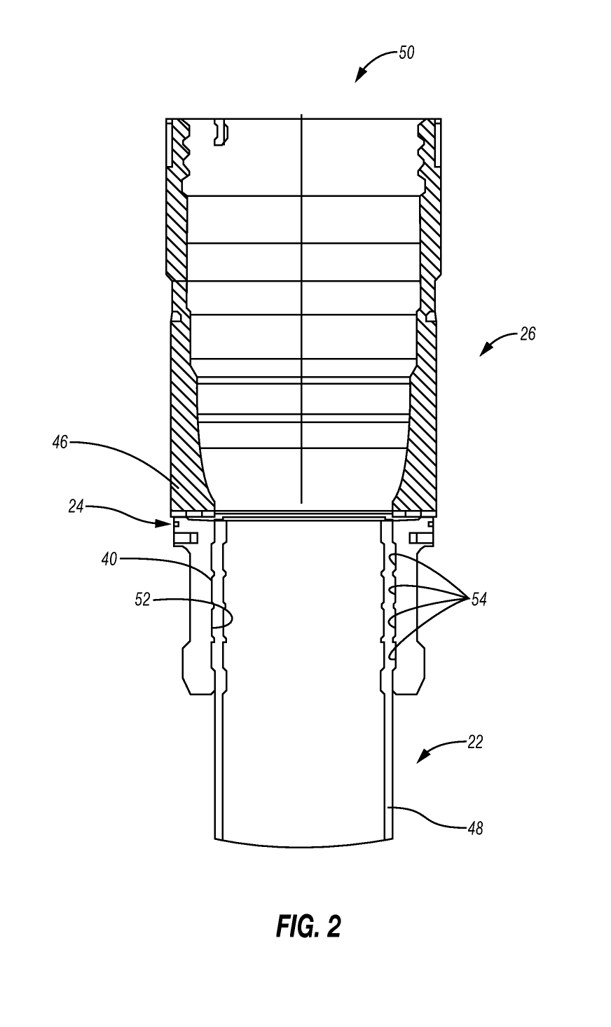

Referring generally to FIG. 2, an embodiment of casing 22 joined with subsea housing 24 is illustrated. In this example, subsea housing 24 is in the form of a low pressure, subsea wellhead housing 46 and casing 22 comprises a large diameter conductor casing 48 which may be inserted down into seabed 28. By way of example, the casing 22/conductor casing 48 may be at least 30 inches in diameter and in some applications is approximately 36 inches in diameter or larger.

In the embodiment illustrated, subsea housing 24 has a passage 50 extending therethrough and which is defined by an inside surface 52. In this example, the upper end 40 of casing 22 is inserted along the inside surface 52 and is expanded in a radially outward direction until coupled with, e.g. sealably coupled with, the inside surface 52. The inside surface 52 may comprise a recess 54 (or recesses 54) into which the casing 22 is expanded to form the sealed connection. By way of example, recesses 54 may be in the form of grooves formed along inside surface 52, e.g. circumferential grooves extending circumferentially about the inside surface 52. When the components 22, 24 are formed of metal, the expansion process effectively forces the metal material of casing 22 into the recesses/grooves 54 to form a secure connection and a metal-to-metal seal between casing 22 and the subsea housing 24.

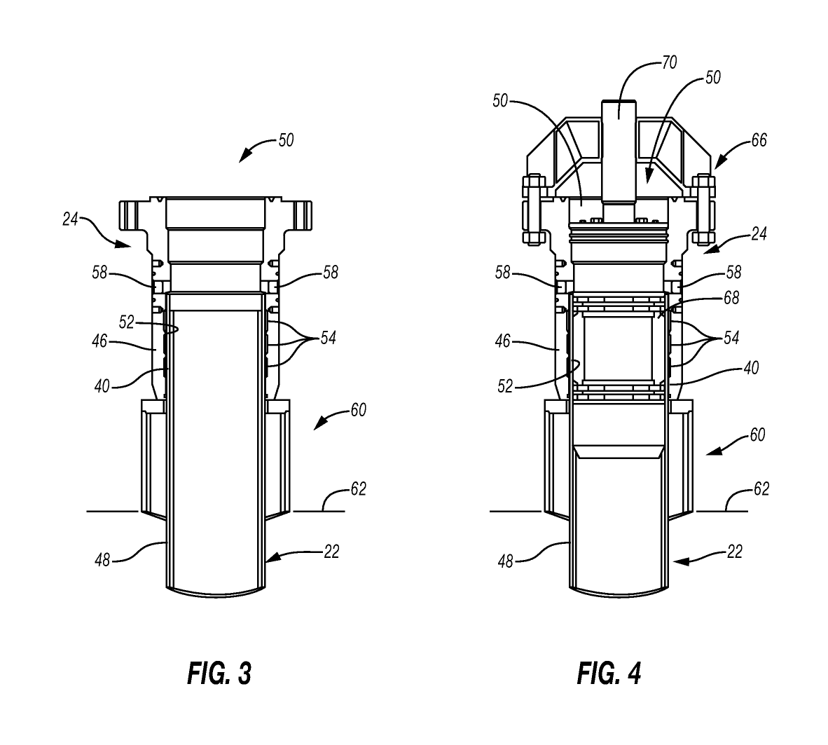

According to an operational example, casing end 40 is properly formed for insertion into subsea housing 24, e.g. into low-pressure wellhead housing 46, as illustrated in FIG. 3. As further illustrated, the low-pressure wellhead housing 46 may comprise various features, such as outlets 58, e.g. flow passage outlets, extending laterally between passage 50 and an exterior of the wellhead housing 46. Various types of casing and/or other equipment may be coupled in fluid communication with the outlets 58.

The conductor casing 48 and corresponding wellhead housing 46 may be assembled on suitable assembly equipment 60. Depending on the parameters of a given application, the assembly equipment 60 may be located at an onshore assembly facility. In some applications, however, assembly may be performed on, for example, a surface facility 62 such as a surface rig which may be in the form of a surface platform, surface vessel, or other suitable facility.

After the top end 40 of casing 22 is inserted in subsea housing 24, an expansion tool 64 is moved through passage 50 and into the interior of casing 22, as illustrated in FIG. 4. As illustrated, the expansion tool 64 initially may be positioned within the end 40 of casing 22 in a radially contracted state. In some embodiments, the expansion tool 64 may be temporarily mounted to subsea housing 24 via a mounting fixture 66 so as to facilitate the expansion of casing 22. The expansion tool 64 may comprise various types of forging tools, such as a mechanical forging tool or a hydraulic forging tool. The illustrated embodiment utilizes an expansion element 68, e.g. an elastomeric mechanical forging element, which may be selectively compressed in an axial direction via an actuator 70. In this example, actuator 70 is a screw type actuator which may be rotated relative to mounting fixture 66 to axially compress expansion element 68. The axial compression, in turn, causes radial expansion of element 68 and thus expansion of the casing 22 in a radially outward direction. It should be noted other types of actuators 70, e.g. other types of forging elements, may be used to radially expand casing 22 to achieve a desired amount of radial expansion.

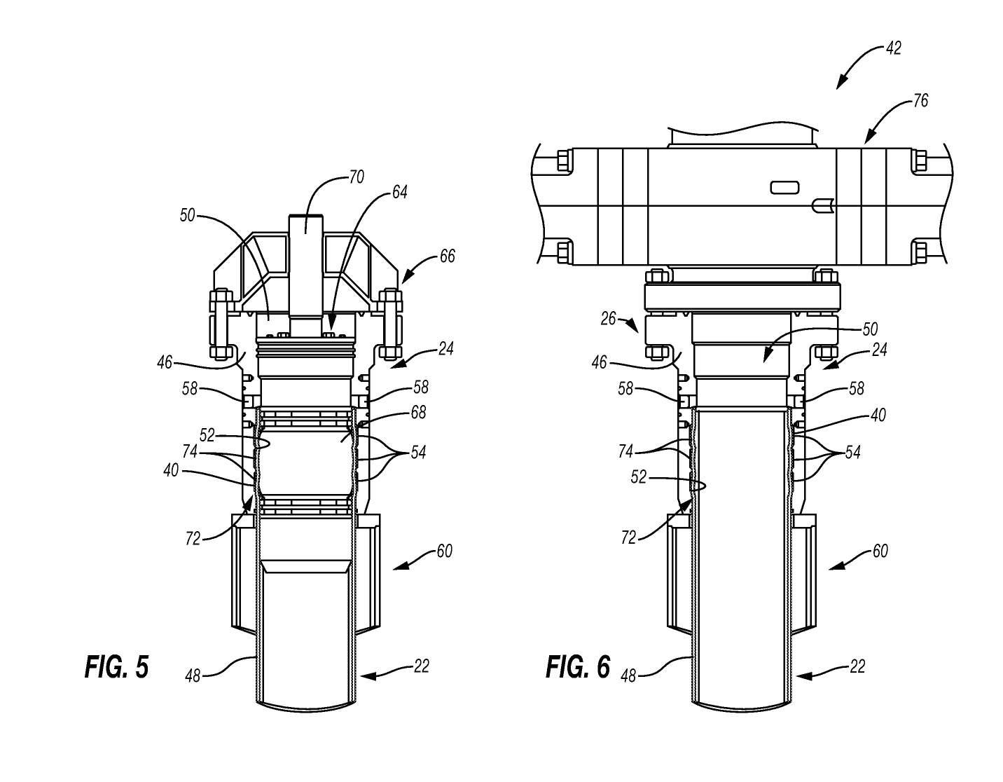

Accordingly, once the expansion tool 64 is positioned within casing 22, the expansion tool 64 may be actuated in a radially outward direction, as illustrated in FIG. 5. The expansion or radially outward movement of expansion tool 64 causes that portion of casing 22, e.g. end 40, to similarly expand in the radially outward direction. The expansion continues and causes the casing 22 to expand beyond yield point of the casing material until the casing 22 securely engages subsea housing 24.

In the example illustrated in FIG. 5, a region of expansion 72 is created as the material of casing 22 is moved into recesses 54 along the inside surface 52 of subsea housing 24. The expansion of casing 22 into the recesses 54 of subsea housing 24 ensures a secure and fixed coupling between casing 22 and subsea housing 24. In this example, sufficient force is applied to casing 22 so as to expand the casing 22 beyond the casing material yield point and to create a metal-to-metal seal 74 between the exterior surface of casing 22 and the interior surface 52 of subsea housing 24.

Following formation of expansion region 72, the expansion tool 64 is radially contracted and removed from passage 50. The expansion region 72 ensures the continued connection between casing 22 and subsea housing 24 while also maintaining the metal-to-metal seal 74. At this stage, a blowout preventer 76 and/or other subsea well installation equipment 42 may be mounted to the subsea housing 24, e.g. subsea wellhead housing 46, as illustrated in FIG. 6. The installation equipment 42 may be mounted to subsea housing 24 before deploying the assembly to the desired subsea location 30 for use with the corresponding well 34. The expansion process may comprise operating the expansion tool 64 at a manufacturing facility (or on the surface facility 62) prior to deploying the casing 22 and subsea housing 24 to the subsea location 30.

Effectively, the approach described herein may be used to form a long, pressed fit sleeve connection between the casing 22 and the subsea housing 24. The coupling technique enables joining of casing 22 and subsea housing 24 without welding and without threaded engagement to provide substantially improved fatigue life characteristics. In various subsea embodiments, for example, the large diameter conductor 48 may be joined with low-pressure wellhead housing 46 without welds or threads. When components are welded, the weld can often be the weak point of the connection so elimination of the weld via the expansion of casing 22 provides a stronger and longer-lasting coupling. The present technique also eliminates the time and cost of welding while enabling joining of less precisely matched components.

Various types of hydraulic or mechanical pressure may be exerted inside the conductor tubing 48 to physically alter the conductor casing 48 until the expansion region 72 is formed. For example, the metal material of conductor casing 48 may swaged into the recesses/grooves 54 along the interior of wellhead housing 64. The expansion, e.g. cold forming, of the material of casing 22 may be achieved by various expansion tools 64 utilizing, for example, a fixed bladder, hydraulic actuation fluids, mechanical fixtures, and/or other types of expansion tools. In some applications, heating and/or cooling also may be used to temporarily expand or contract the components to facilitate coupling of the components, e.g. casing 22 and subsea housing 24. The plastic deformation of casing 22 may be used to permanently transition material into the recesses/grooves 54 so as to permanently affix and seal the casing 22 with respect to the subsea housing 24 in a manner which provides desired axial, rotational, and pressure characteristics.

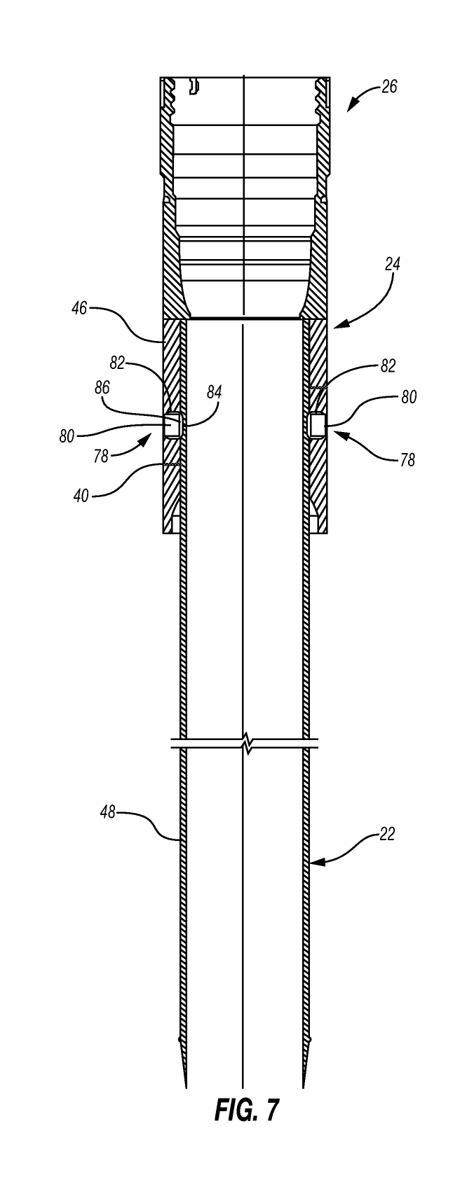

Referring generally to FIG. 7, another embodiment of well system 20 is illustrated. In this example, the casing 22 is again inserted into the subsea housing 24. However, a plurality of coupling members 78 may be used to secure the casing 22 within the subsea housing 24. By way of example, the coupling members 78 may be positioned circumferentially about the subsea housing 24 and may be transitioned radially into engagement with the casing 22.

The coupling members 78 may comprise various types of members which securely connect the two components 22, 24. In the example illustrated, the coupling members 78 comprise activating bolts 80 which are threadably mounted in corresponding passages 82 extending radially through the wall forming subsea housing 24 as illustrated. After inserting casing 22 into the subsea housing 24, the activating bolts 80 may be rotated and thus transitioned radially inward into engagement with the tubing 22.

By way of example, the radially inward ends of activating bolts 80 may be received in a recess 84, e.g. a cold rolled groove, formed in the exterior surface of casing 22. In some embodiments, an inwardly biased C-ring 86 may be positioned between the activating bolts 80 and recess/groove 84. When the activating bolts 80 are tightened, the C-ring 86 is securely held within the recess/groove 84 to securely connect casing 22 and subsea housing 24.

Depending on the specifics of a given use, the shape, size, and features of casing 22 and the subsea housing 24 may be adjusted. For example, the casing 22 may have various diameters for use with various types of subsea housings 24. In certain subsea operations, the casing 22 is formed as large diameter conductor casing 48 and may be used to position wellhead housing 46 at a desired spacing above the sea floor 32. Various jetting and/or drilling techniques may be used for positioning the large diameter conductor 48 in a desired position and orientation with respect to well 34. Additionally, the wellhead housing 46 may have many types of outlets and other features for use in cooperation with many types of subsea installation equipment 76. The types of expansion tools 64 as well as the materials used in forming casing 22 and/or subsea housing 24 may be selected according to the parameters of a given subsea operation.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A system for use in a subsea well operation, comprising:
a subsea wellhead housing positioned at a subsea location and having an inside surface with a plurality of internal recesses; and
a large diameter conductor casing extending into a subsea geologic formation at the subsea location, the large diameter conductor casing having an upper end disposed directly along the inside surface within the subsea wellhead housing, the upper end being expanded into the plurality of internal recesses to form a metal-to-metal seal between an exterior surface of the large diameter conductor and the inside surface of the subsea wellhead housing to provide an unobstructed passage along an interior surface of the large diameter conductor.

2. The system as recited in claim 1, further comprising a well tubular extending from the large diameter conductor casing downhole into a wellbore formed in the subsea geologic formation.

3. The system as recited in claim 1, wherein the plurality of internal recesses comprises a plurality of circumferential grooves.

4. The system as recited in claim 1, wherein the metal-to-metal seal is formed without welding.

5. The system as recited in claim 4, wherein the seal between the upper end of the large diameter conductor tubing and the subsea wellhead housing is formed without threaded engagement.

6. The system as recited in claim 1, wherein the subsea wellhead housing is a low-pressure housing.

7. The system as recited in claim 1, wherein the large diameter conductor casing has a diameter of at least 30 inches.

8. The system as recited in claim 1, wherein the subsea wellhead housing comprises a plurality of outlets.

9. A method, comprising:
moving a tubular element of a casing into a wellhead housing such that an external surface of the tubular element is adjacent an inside surface of the wellhead housing;
engaging an internal surface of the tubular element with an expansion tool;
operating the expansion tool to expand the tubular element in a radially outward direction;
applying sufficient force via the expansion tool to continue the radial expansion of the tubular element until a metal-to-metal seal is formed between the external surface of the tubular element and the inside surface of the wellhead housing; and
removing the expansion tool from the tubular element to provide an unobstructed passage along the internal surface of the tubular element.

10. The method as recited in claim 9, further comprising moving the tubular element into the seabed at a subsea well.

11. The method as recited in claim 10, further comprising mounting subsea equipment to the wellhead housing.

12. The method as recited in claim 9, wherein applying sufficient force comprises expanding the tubular element into recesses formed along an interior of the wellhead housing.

13. The method as recited in claim 9, wherein applying sufficient force comprises expanding the tubular element into circumferential grooves formed along an interior of the wellhead housing.

14. The method as recited in claim 9, wherein operating the expansion tool comprises operating a mechanical forging element.

15. The method as recited in claim 9, wherein operating comprises operating the expansion tool on a surface vessel prior to deploying the tubular element and the wellhead housing to a subsea location.

16. The method as recited in claim 9, wherein operating comprises operating the expansion tool at an assembly facility prior to delivering the tubular element and the wellhead housing to a subsea location.

17. A system, comprising:
a subsea low-pressure housing having an interior surface with a plurality of recesses; and
a casing having an exterior surface, the casing being inserted into the subsea low-pressure housing such that the exterior surface of the casing is disposed directly along the interior surface of the subsea low-pressure housing, the casing being expanded into the plurality of recesses to thus form a metal-to-metal seal, an internal surface of the casing being exposed to provide an unobstructed passage through the casing upon forming the metal-to-metal seal.

18. The system as recited in claim 17, wherein the casing is a conductor casing inserted into the seabed at a subsea well.

19. The system as recited in claim 17, wherein the plurality of recesses comprises a plurality of circumferential grooves.

20. The system as recited in claim 18, wherein the subsea low-pressure housing comprises a wellhead housing held above the seabed by the conductor casing.
